(19) United States
(12) Patent Application Publication
(10) Pub. No.: US 2020/0342312 A1
(43) Pub. Date: Oct. 29, 2020

(54) PERFORMING A HIERARCHICAL SIMPLIFICATION OF LEARNING MODELS

(71) Applicant: International Business Machines Corporation, Armonk, NY (US)

(72) Inventors: Takeshi Inagaki, Tokyo (JP); Aya Minami, Tokyo (JP)

(21) Appl. No.: 16/397,919

(22) Filed: Apr. 29, 2019

(51) Int. Cl. G06N 3/08; G06N 3/04

(52) U.S. Cl. CPC G06N 3/08; G06N 3/04

(57) ABSTRACT

A computer-implemented method according to one embodiment includes applying a first instance of input to a first model within a tree structure, activating a second model within the tree structure, based on an identification of a first topic within the first instance of input by the first model, applying a second instance of input to the first model and the second model, activating a third model within the tree structure, based on an identification of a second topic within the second instance of input by the second model, applying a third instance of input to the first model, the second model, and the third model, and outputting, by the third model, an identification of a third topic, utilizing the third instance of input.

### BACKGROUND

The present invention relates to machine learning, and more specifically, this invention relates to training and utilizing neural networks.

Machine learning is commonly used to provide data analysis. For example, neural networks may be used to identify predetermined data within provided input. However, these neural networks are often complex, and have numerous inputs and outputs. As a result, the creation and preparation of the training data necessary to train these neural networks is resource and time-consuming. There is therefore a need to simplify the organization or neural networks in order to simplify and reduce an amount of training data needed to train such neural networks.

### SUMMARY

A computer-implemented method according to one embodiment includes applying a first instance of input to a first model within a tree structure, activating a second model within the tree structure, based on an identification of a first topic within the first instance of input by the first model, applying a second instance of input to the first model and the second model, activating a third model within the tree structure, based on an identification of a second topic within the second instance of input by the second model, applying a third instance of input to the first model, the second model, and the third model, and outputting, by the third model, an identification of a third topic, utilizing the third instance of input.

According to another embodiment, a computer program product for performing a hierarchical simplification of learning models includes a computer readable storage medium having program instructions embodied therewith, where the computer readable storage medium is not a transitory signal per se, and where the program instructions are executable by a processor to cause the processor to perform a method including applying, by the processor, a first instance of input to a first model within a tree structure, activating, by the processor, a second model within the tree structure, based on an identification of a first topic within the first instance of input by the first model, applying, by the processor, a second instance of input to the first model and the second model, activating, by the processor, a third model within the tree structure, based on an identification of a second topic within the second instance of input by the second model, applying, by the processor, a third instance of input to the first model, the second model, and the third model, and outputting, by the third model, an identification of a third topic, utilizing the processor and the third instance of input.

A system according to another embodiment includes a processor, and logic integrated with the processor, executable by the processor, or integrated with and executable by the processor, where the logic is configured to apply a first instance of input to a first model within a tree structure, activate a second model within the tree structure, based on an identification of a first topic within the first instance of input by the first model, apply a second instance of input to the first model and the second model, activate a third model within the tree structure, based on an identification of a second topic within the second instance of input by the second model, apply a third instance of input to the first model, the second model, and the third model, and output, by the third model, an identification of a third topic, utilizing the third instance of input.

A computer-implemented method according to another embodiment includes identifying a complex model that determines a plurality of topics within input data, decomposing the complex model into a plurality of simplified models, where each simplified model is associated with one of the plurality of topics and identifies the one of the plurality of topics within the input data, determining a relationship between the plurality of topics, arranging the plurality of simplified models into a hierarchical tree structure, based on the relationship between the plurality of topics, training each of the plurality of simplified models within the hierarchical tree structure, and applying the trained plurality of simplified models to the input data.

According to another embodiment, a computer program product for performing a hierarchical simplification of learning models includes a computer readable storage medium having program instructions embodied therewith, where the computer readable storage medium is not a transitory signal per se, and where the program instructions are executable by a processor to cause the processor to perform a method including identifying, by the processor, a complex model that determines a plurality of topics within input data, decomposing, by the processor, the complex model into a plurality of simplified models, where each simplified model is associated with one of the plurality of topics and identifies the one of the plurality of topics within the input data, determining, by the processor, a relationship between the plurality of topics, arranging, by the processor, the plurality of simplified models into a hierarchical tree structure, based on the relationship between the plurality of topics, training, by the processor, each of the plurality of simplified models within the hierarchical tree structure, and applying, by the processor, the trained plurality of simplified models to the input data.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 illustrates a method for performing a hierarchical simplification of learning models, in accordance with one embodiment.

FIG. 4 illustrates a method for arranging neural network models in a hierarchical tree structure, in accordance with one embodiment.

FIG. 5 illustrates an exemplary model tree structure, in accordance with one embodiment.

FIG. 6 illustrates a superordinate/subordinate relationship tree, in accordance with one embodiment.

FIG. 7 illustrates a specific application of a superordinate/subordinate relationship tree to input data, in accordance with one embodiment.

### DETAILED DESCRIPTION

The following description discloses several preferred embodiments of systems, methods and computer program products for performing a hierarchical simplification of learning models. Various embodiments provide a method to hierarchically arrange and apply to input data a group of individual topic-identification models within a tree structure.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “includes” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for performing a hierarchical simplification of learning models.

In one general embodiment, a computer-implemented method includes applying a first instance of input to a first model within a tree structure, activating a second model within the tree structure, based on an identification of a first topic within the first instance of input by the first model, applying a second instance of input to the first model and the second model, activating a third model within the tree structure, based on an identification of a second topic within the second instance of input by the second model, applying a third instance of input to the first model, the second model, and the third model, and outputting, by the third model, an identification of a third topic, utilizing the third instance of input.

In another general embodiment, a computer program product for performing a hierarchical simplification of learning models includes a computer readable storage medium having program instructions embodied therewith, where the computer readable storage medium is not a transitory signal per se, and where the program instructions are executable by a processor to cause the processor to perform a method including applying, by the processor, a first instance of input to a first model within a tree structure, activating, by the processor, a second model within the tree structure, based on an identification of a first topic within the first instance of input by the first model, applying, by the processor, a second instance of input to the first model and the second model, activating, by the processor, a third model within the tree structure, based on an identification of a second topic within the second instance of input by the second model, applying, by the processor, a third instance of input to the first model, the second model, and the third model, and outputting, by the third model, an identification of a third topic, utilizing the processor and the third instance of input.

In another general embodiment, a system includes a processor, and logic integrated with the processor, executable by the processor, or integrated with and executable by the processor, where the logic is configured to apply a first instance of input to a first model within a tree structure, activate a second model within the tree structure, based on an identification of a first topic within the first instance of input by the first model, apply a second instance of input to the first model and the second model, activate a third model within the tree structure, based on an identification of a second topic within the second instance of input by the second model, apply a third instance of input to the first model, the second model, and the third model, and output, by the third model, an identification of a third topic, utilizing the third instance of input.

In another general embodiment, a computer-implemented method includes identifying a complex model that determines a plurality of topics within input data, decomposing the complex model into a plurality of simplified models, where each simplified model is associated with one of the plurality of topics and identifies the one of the plurality of topics within the input data, determining a relationship between the plurality of topics, arranging the plurality of simplified models into a hierarchical tree structure, based on the relationship between the plurality of topics, training each of the plurality of simplified models within the hierarchical tree structure, and applying the trained plurality of simplified models to the input data.

In another general embodiment, a computer program product for performing a hierarchical simplification of learning models includes a computer readable storage medium having program instructions embodied therewith, where the computer readable storage medium is not a transitory signal per se, and where the program instructions are executable by a processor to cause the processor to perform a method including identifying, by the processor, a complex model that determines a plurality of topics within input data, decomposing, by the processor, the complex model into a plurality of simplified models, where each simplified model is associated with one of the plurality of topics and identifies the one of the plurality of topics within the input data, determining, by the processor, a relationship between the plurality of topics, arranging, by the processor, the plurality of simplified models into a hierarchical tree structure, based on the relationship between the plurality of topics, training, by the processor, each of the plurality of simplified models within the hierarchical tree structure, and applying, by the processor, the trained plurality of simplified models to the input data.

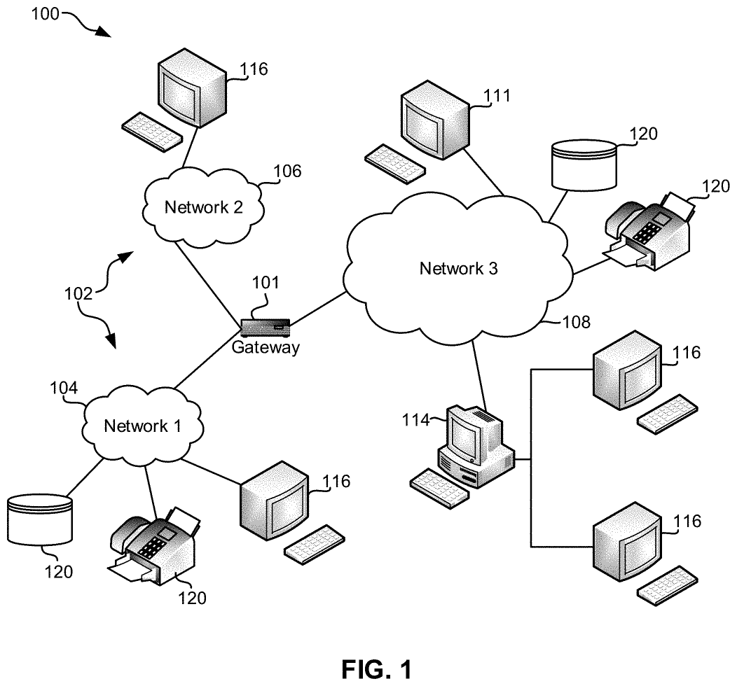

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

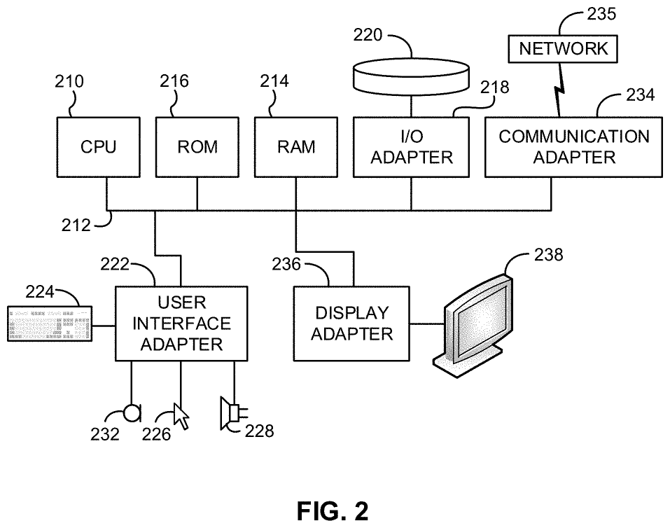

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

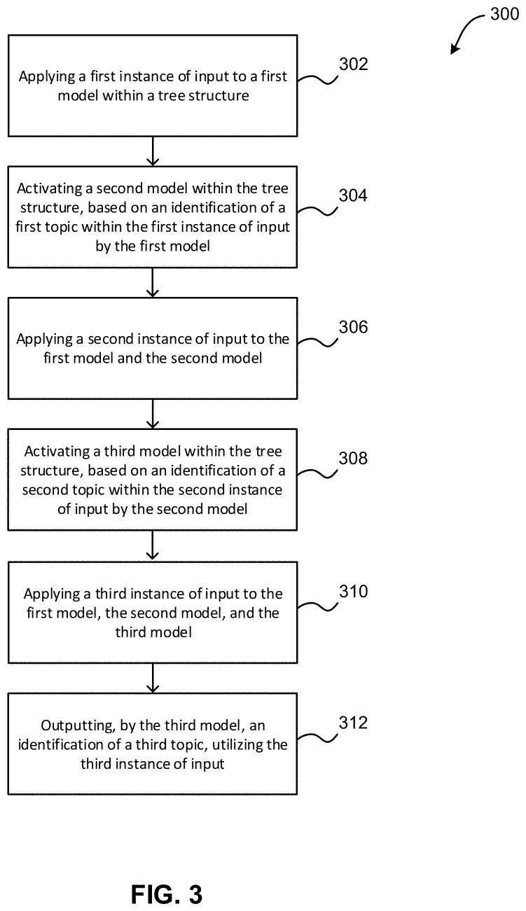

Now referring to FIG. 3, a flowchart of a method 300 is shown according to one embodiment. The method 300 may be performed in accordance with the present invention in any of the environments depicted in FIGS. 1-2 and 5-6, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where a first instance of input is applied to a first model within a tree structure. In one embodiment, the first model may include a learning model such as a first neural network. In another embodiment, the tree structure may represent a plurality of individual models, as well as an interrelationship between the models. For example, each model within the tree structure may include a learning model such as a neural network.

Additionally, in one embodiment, the tree structure may include a root model, one or more intermediate models, and one or terminal models. For example, the root model may include an initial model to which all other models in the tree structure depend. For instance, the root model may not be dependent upon any other model within the tree structure. In another example, intermediate models may include models within the tree structure that depend from another model, but also have models upon which they are depended upon (e.g., child models within the tree structure, etc.). In yet another example, the terminal models may include models that depend from another model, but have no models that depend on them (e.g., leaf models within the tree structure, etc.).

Further, in one embodiment, the tree structure may be arranged based on topic. For example, each of the plurality of models may be associated with a single topic different from the other models. For instance, each of the plurality of models may store word sequences for individual topics. The topic may include a keyword, a variation of a keyword, etc. In another example, each of the plurality of models may analyze input in order to determine if the single topic associated with the model is found within the input. In yet another example, each model may be labeled with the single topic to which it is associated.

Further still, in one embodiment, each of the plurality of topics may be analyzed in order to determine relationships between the topics. In another embodiment, superordinate/subordinate topics may be determined within the plurality of topics. For example, a first topic may always be found to precede a second topic within provided input. In another example, the first topic may then be identified as superordinate to the second topic, and the second topic may be identified as subordinate to the first topic.

Also, in one embodiment, the plurality of models may be arranged within the tree structure based on these topics/relationships. For example, subordinate models may be arranged as children of superordinate models within the tree structure. In the above example, the second topic may be arranged as a child of the first topic within the tree structure.

In addition, in one embodiment, the first model may include a root model within the tree structure. In another embodiment, the first module may include a classification module that outputs a label (e.g., a topic) based on provided input. For example, the label can include an identification a predetermined topic within the provided input.

Furthermore, in one embodiment, the first instance of input may include textual data, audio data, time series data, etc. In another embodiment, the first instance of input may include a first portion of input data. For example, the input data may include a textual document, an audio recording, etc. In another example, the input data may be divided into a plurality of portions. In yet another example, the plurality of portions may be arranged chronologically (e.g., such that a first portion is located before a second portion, a second portion is located before a third portion, etc.).

Further still, method 300 may proceed with operation 304, where a second model is activated within the tree structure, based on an identification of a first topic within the first instance of input by the first model. In one embodiment, the first instance of input may be analyzed by first model, where the first model is associated with the first topic. In another embodiment, the first model may identify the first topic within the first instance of input.

Also, in one embodiment, in response to the identification of the first topic within the first instance of input, all children of the first model within the tree structure may be activated. For example, the second model may include a child model of the first model within the tree structure. In another example, the second model may be applied to subsequent input, along with the first model.

Additionally, in one embodiment, the second model may include a learning model such as a second neural network separate from the first neural network. In another embodiment, the second model may include an intermediate model within the tree structure. For example, the second model may have one or more children within the tree structure. In another example, the second module may include a classification module that outputs a label (e.g., a topic) based on provided input.

Further, method 300 may proceed with operation 306, where a second instance of input is applied to the first model and the second model. In one embodiment, the second instance of input may include a second portion of input data occurring after a first portion of input data (e.g., within a chronologically arranged plurality of portions of input, etc.).

Further still, method 300 may proceed with operation 308, where a third model is activated within the tree structure, based on an identification of a second topic within the second instance of input by the second model. In one embodiment, the second instance of input may be analyzed by first model and the second model, where the first model is associated with a first topic and the second model is associated with the second topic. In another embodiment, the second model may identify the second topic within the second instance of input.

Also, in one embodiment, in response to the identification of the second topic within the first instance of input, all children of the second model within the tree structure may be activated. For example, the third model may include a child model of the second model within the tree structure. In another example, the third model may be applied to subsequent input, along with the first model and the second model.

In addition, in one embodiment, the third model may include a learning model such as a third neural network separate from the first neural network and the second neural network. In another embodiment, the third model may include a terminal model within the tree structure. For example, the third model may have no children within the tree structure. In another example, the third module may include a classification module that outputs a label (e.g., a topic) based on provided input.

Furthermore, method 300 may proceed with operation 310, where a third instance of input is applied to the first model, the second model, and the third model. In one embodiment, the third instance of input may include a third portion of input data occurring after a second portion of input data (e.g., within a chronologically arranged plurality of portions of input, etc.).

Further still, method 300 may proceed with operation 312, where an identification of a third topic is output by the third model, utilizing the third instance of input. In one embodiment, the third model may analyze the third instance of input and may output a label.

In this way, a group of individual topic-identification models arranged hierarchically in a tree structure by the topics they identify may be applied to input data, where models within the group are activated and applied to later portions of the input data based on earlier topic identifications within earlier portions of the input data. This group of individual models may have a much smaller complexity than a single model that performs an identification of multiple topics, and as a result, the group of individual models may require much less training data and training time when compared to the single model. This may reduce an amount of storage space, processor utilization, and memory usage to train and implement topic-identification models, which may improve a performance of computing devices performing such training and implementation.

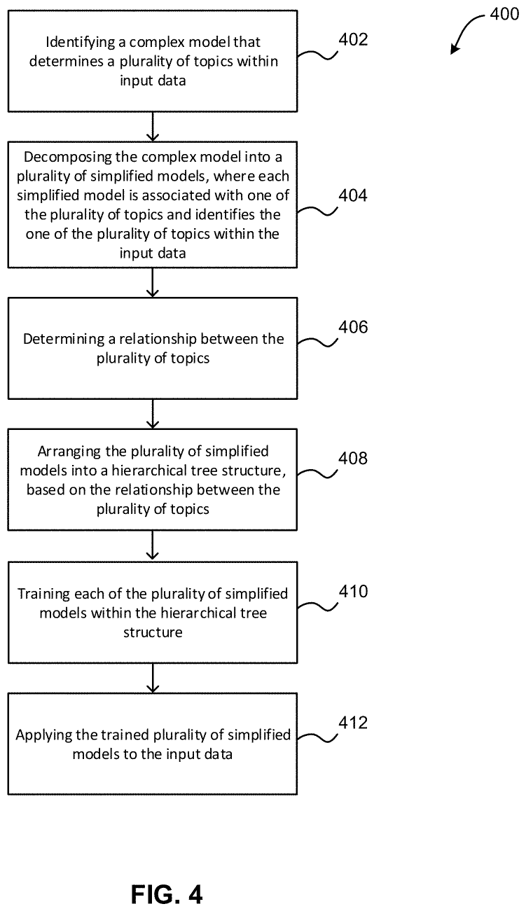

Now referring to FIG. 4, a flowchart of a method 400 for arranging neural network models in a hierarchical tree structure is shown according to one embodiment. The method 400 may be performed in accordance with the present invention in any of the environments depicted in FIGS. 1-2 and 5-6, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a complex model is identified that determines a plurality of topics within input data. In one embodiment, the complex model may include a single neural network.

Additionally, method 400 may proceed with operation 404, where the complex model is decomposed into a plurality of simplified models, where each simplified model is associated with one of the plurality of topics and identifies the one of the plurality of topics within the input data. In one embodiment, each simplified model may be associated with a topic different from the other topics associated with the other models (e.g., each topic may be unique).

Further, method 400 may proceed with operation 406, where a relationship between the plurality of topics is determined. In one embodiment, the relationship may be predefined, may be determined based on a topic relationship analysis, etc. In another embodiment, superordinate/subordinate topics may be determined within the plurality of topics.

Further still, method 400 may proceed with operation 408, where the plurality of simplified models are arranged into a hierarchical tree structure, based on the relationship between the plurality of topics. In one embodiment, subordinate models to a given superordinate model may be arranged as children of the superordinate model within the tree structure.

Also, method 400 may proceed with operation 410, where each of the plurality of simplified models are trained within the hierarchical tree structure. In one embodiment, each of the plurality of simplified models may be trained utilizing predetermined instances of training data.

In addition, method 400 may proceed with operation 412, where the trained plurality of simplified models are applied to the input data. In one embodiment, the input data may include data that is sequentially organized. For example, the input data may have a consistent order, with a first portion of the input data always occurring before a second portion of the input data. In another embodiment, a predetermined simplified model (e.g., a root model or an immediate child of a root model, etc.) may be initially applied to a first portion of the input data. For example, the first portion of the input data may include a predetermined portion of the input data within the sequential organization.

Furthermore, in one embodiment, in response to the identification of a topic by the predetermined simplified model, child models of the predetermined simplified model within the tree structure may be activated and applied to a second portion of the input data. In another embodiment, model activation may be performed until the input data is entirely processed, or terminal models of the predetermined simplified model are activated and applied.

As a result, an amount of training data needed to train the plurality of simplified models may be less than an amount of training data needed to train the complex model. For example, if the complex model has M inputs and N outputs, training data on the order of M×N is necessary for training the complex model. By decomposing the complex model into M simplified models each having one input, training data on the order of M+N is necessary for training the simplified model. This reduces the amount of training data necessary during topic identification, and may reduce an amount of storage, processing, and resource utilization of computing devices performing such training, which may improve a performance of such computing devices.

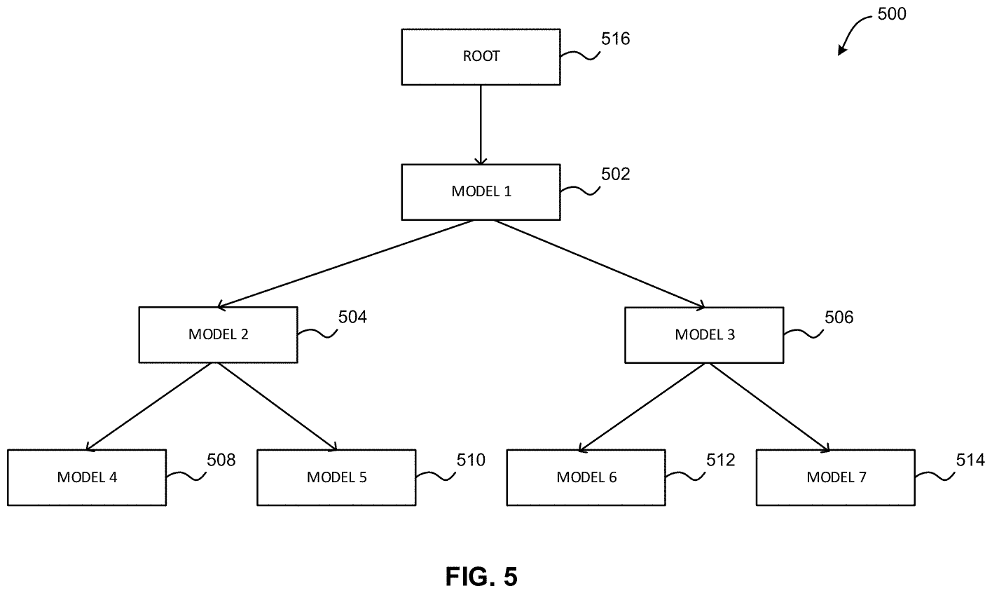

FIG. 5 illustrates an exemplary model tree structure 500, according to one exemplary embodiment. As shown, a plurality of models 502-514 are arranged in the tree structure 500. In one embodiment, each of the plurality of models 502-514 may include a single independent neural network. In another embodiment, each of the plurality of models 502-514 may take textual, audio, and/or time series data as input, and may search for a predetermined topic within that input. For example, each of the plurality of models 502-514 may search for a predetermined topic different from the other plurality of models 502-514, and may output a first predetermined value if the predetermined topic is identified within the input (a second predetermined value may be output if the predetermined topic is not identified within the input).

Additionally, in one embodiment, each of the plurality of models 502-514 may be associated with a predetermined topic, and the arrangement of the tree structure 500 may be based on relationships between the topics. For example, each of the plurality of models 502-514 may be associated with a predetermined topic, where the predetermined topic includes the topic searched for by the model. Predetermined superordinate/subordinate relationships between each of the topics may be provided, and these relationships may be used to create the tree structure 500.

For example, the provided superordinate/subordinate relationships may indicate that a topic searched for by the second model 504 and a topic searched for by the third model 506 are subordinate to a topic searched for by a first model 502, and the second model 504 and the third model 506 are arranged within the tree structure 500 as children of the first model 502 as a result. Likewise, the provided superordinate/subordinate relationships may indicate that a topic searched for by the fourth model 508 and a topic searched for by the fifth model 510 are subordinate to a topic searched for by the second model 504, and the fourth model 508 and the fifth model 510 are arranged within the tree structure 500 as children of the second model 504 as a result. Further, the provided superordinate/subordinate relationships may indicate that a topic searched for by the sixth model 512 and a topic searched for by the seventh model 514 are subordinate to a topic searched for by the third model 506, and the sixth model 512 and the seventh model 514 are arranged within the tree structure 500 as children of the third model 506 as a result.

Further still, it may be determined that the fourth model 508, fifth model 510, sixth model 512, and seventh model 514 do not have any subordinate models. As a result, these models may be arranged as terminal nodes within the tree structure 500. Since the second model 504 and the third model 506 have subordinate nodes, these models may be arranged as intermediate nodes within the tree structure 500.

Also, in one embodiment, a first model 502 that is subordinate only to a root 516 of the tree structure 500 may be activated and provided the first instance of input. In another embodiment, the first instance of input may include a first portion of a plurality of sequentially organized instances of input. In yet another embodiment, the first model 502 may be associated with a first predetermined topic, and may search for the first predetermined topic within the first instance of input.

In addition, in response to an identification of the first predetermined topic in the first instance of input by the first model 502, all children of the first model 502 within the tree structure 500 (e.g., the second model 504 and the third model 506) are activated and provided the second instance of input along with the first model 502. In one embodiment, the second instance of input may include a second portion of the plurality of sequentially organized instances of input, occurring immediately after the first instance of input. In another embodiment, the second model 504 and the third model 506 may be associated with a second predetermined topic and a third predetermined topic, respectively, and may search for their predetermined topics within the second instance of input.

Furthermore, in response to an identification of the second predetermined topic in the second instance of input by the second model 504, all children of the second model 504 within the tree structure 500 (e.g., the fourth model 508 and the fifth model 510) are activated and provided the third instance of input along with the first model 502, the second model 504, and the third model 506. In one embodiment, the third instance of input may include a third portion of the plurality of sequentially organized instances of input, occurring immediately after the second instance of input. In another embodiment, the fourth model 508 and the fifth model 510 may be associated with a fourth predetermined topic and a fifth predetermined topic, respectively, and may search for their predetermined topics within the third instance of input.

In this way, each of the plurality of models 502-514 may be trained to identify a single associated topic within the input, instead of training a single model to identify all associated topics. This may reduce an amount of resources utilized by a computing device that performs the training, thereby improving a performance of the computing device. Additionally, the plurality of models 502-514 may be selectively applied to input according to their arrangement within the tree structure 500, and may therefore identify associated topics in a similar manner as a single model trained to identify all associated topics.

### Generating Machine Readable Business Process Definitions from Text Documents Written in Natural Human Language

In natural language processing using mechanical learning, the primary problem for accuracy enhancement is the securing of a sufficient number of learning data. In general, use of a learning model with high writing performance requires the amount of learning data proportional to the learning performance for training the learning model. Generally, the learning amount may be considered as the number of parameters in the model.

In the case of three inputs and two outputs, the number of internal parameters (weight coefficients for inputs) is six. If an input is allowed as the fourth input, the number of internal parameters increases to eight. Furthermore, if three outputs are provided, the number of parameters becomes twelve. In order to determine these parameters by means of learning, at least the same number of learning data as the parameters are required.

In order to train a model that performs efficient learning (that is, solves a problem using minimum learning data), it is necessary to build a learning model of the smallest possible size and form optimized to a problem. Therefore, the following approach will be taken:

1. Combine small models in an externally-designated superordinate/subordinate relationship to build one model.
2. The built model operates while dynamically changing in its entirety by changing models activated in the lower layer based on the result of detection of chronologically provided data in the upper layer, according to the superordinate/subordinate relationship.

Although in order to learn all of conditions via a single large network, learning data covering all of the cases is required, combining multiple small networks enables a reduction in cost for such learning data. In order to combine small networks, information for designating how they are combined is required, but, here, it is assumed that such information can be pre-defined. Generally speaking, the learning cost for the information for the externally-designated logical structure is thus saved.

In the case of analysis of a text document written in a natural language, the overall learning model is created by creating multiple small models that store word sequences for individual topics and externally designating the superordinate/subordinate relationship among the topics, rather than creating a learning model that stores work sequences included in the entire text document. This corresponds to the way of thinking when a person reads a document, that is, specifying the area that is the topic to narrow down topics that are likely to be discussed afterward facilitating understanding because items to be determined are thus reduced.

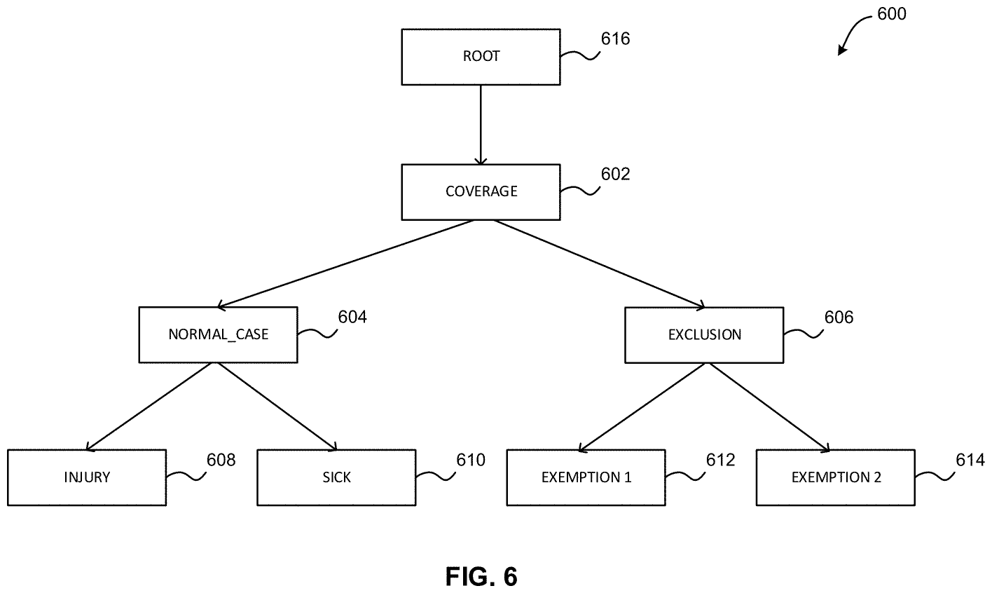

FIG. 6 illustrates a superordinate/subordinate relationship tree 600, according to one exemplary embodiment. Each model 602-614 indicates a topic and directed links indicate a superordinate/subordinate relationship. Within the tree 600, children are subordinate to respective parents.

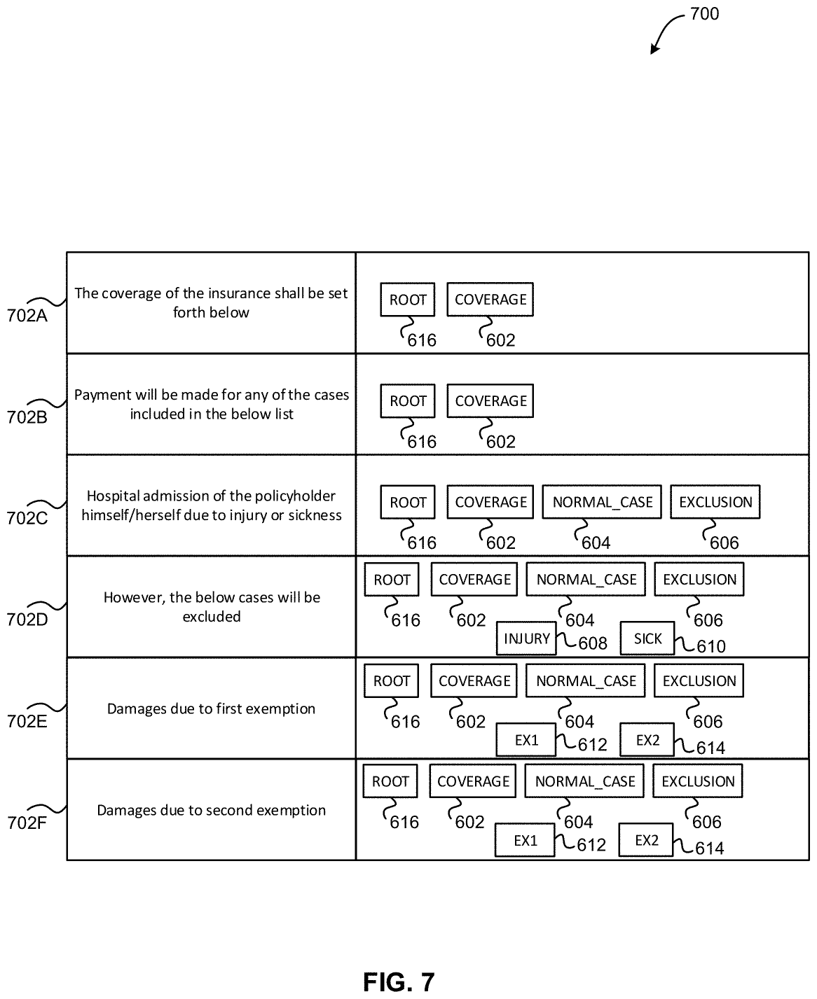

Analysis of a text is sequentially performed from the beginning of the text based on the respective sentences or sections similar to the sentences. Along with detection of a parent topic in a sentence under the analysis, models that each detect a child topic subordinate to the parent topic are automatically activated. A specific application 700 of the tree 600 to input data is illustrated in FIG. 7.

As shown in FIG. 7, in an initial state, only the COVERAGE model 602, which is subordinate only to the ROOT 616 of the tree 600 of FIG. 6, is activated. When the topic “coverage” is detected by the COVERAGE model 602 in the first line of input 702A (e.g., in response to the detection of the term “coverage”), the NORMAL_CASE model 604 and the EXCLUSION model 606, which are subordinate to the COVERAGE model 602 within the tree 600 of FIG. 6, are activated and applied to the second line of input 702B.

When the topic “NORMAL CASE” is detected by the NORMAL_CASE model 604 in the second line of input 702B (e.g., in response to the detection of the term “cases”), the INJURY model 608 and the SICK model 610 are activated based on the superordinate/subordinate relationship within the tree 600 of FIG. 6, and are applied to the third line of input 702C. The topic “INJURY” is detected by the INJURY model 608 (e.g., in response to the detection of the term “injury”), and the topic “SICK” is detected by the SICK model 610 (e.g., in response to the detection of the term “sick”) within the third line of input 702C.

When the topic “EXCLUSION” is detected by the EXCLUSION model 606 in the fourth line of input 702D (e.g., in response to the detection of the term “excluded”), the INJURY model 608 and the SICK model 610 are deactivated and instead, the EXEMPTION1 model 612 and the EXEMPTION2 model 614, which are subordinate to the EXCLUSION model 606 within the tree 600 of FIG. 6, are activated.

The topic “EXEMPTION1” is detected by the EXEMPTION1 model 612 (e.g., in response to the detection of the term “first exemption”), and the topic “EXEMPTION2” is detected by the EXEMPTION2 model 614 (e.g., in response to the detection of the term “second exemption”) within the fifth line of input 702E and the sixth line of input 702F, respectively.

In one embodiment, an analysis engine may operate while changing activated models based on the indication of the superordinate/subordinate relationship. Exemplary code implementing such an analysis engine is shown in Table 1.

TABLE 1

```
[{
  element=″COVERAGE″
  contains=[
    {
      element=″NORMAL_CASE″,
      contains=[{
        element=″INJURY″
        },{
        element=″SICK″
        }]
    },{
      element=″INCLUSION″,
      contains=[{
        element=″EXEMPTION1″
      },{
        element=″EXEMPTION2″
      }]
    }
  ]
}]
```

Where a component having M options and a component having N options are combined, there are M×N options. In order to set this model by means of mechanical learning, learning data on the order of M×N is required. On the other hand, if the components are learned individually, only learning data on the order of M+N is required. This can be regarded as the effect of elimination of options in unnecessary combinations by explicitly indicating that the two components are logically independent in a model in the form of tree separation.

In one embodiment, a method of labeling input data includes creating a learning model of a tree structure for labeling the input data, including creating a learning model of a tree structure for labeling the input data, wherein the model of the tree structure is created from a terminal model based on a dependency relationship. Additionally, chronologically organized input data is read from a start of the input data, and models are applied starting at a root of the tree structure. Further, models are selectively activated and applied within the tree structure based on a detection result of the model. Further still, the input data is labelled based on the detection results of the activated and applied models.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
applying a first instance of input to a first model within a tree structure;
activating a second model within the tree structure, based on an identification of a first topic within the first instance of input by the first model;
applying a second instance of input to the first model and the second model;
activating a third model within the tree structure, based on an identification of a second topic within the second instance of input by the second model;
applying a third instance of input to the first model, the second model, and the third model; and
outputting, by the third model, an identification of a third topic, utilizing the third instance of input.

2. The computer-implemented method of claim 1, wherein the first model includes a first neural network.

3. The computer-implemented method of claim 1, wherein the tree structure represents a plurality of individual models, as well as an interrelationship between the individual models.

4. The computer-implemented method of claim 1, wherein the tree structure is arranged based on topic.

5. The computer-implemented method of claim 1, wherein first module includes a classification module that outputs a topic based on provided input.

6. The computer-implemented method of claim 1, wherein first instance of input is selected from a group consisting of textual data, audio data, and time series data.

7. The computer-implemented method of claim 1, wherein in response to the identification of the first topic within the first instance of input, all children of the first model within the tree structure are activated.

8. The computer-implemented method of claim 1, wherein the first model includes a root model within the tree structure, the second model includes an intermediate model within the tree structure, and the third model includes a terminal model within the tree structure.

9. The computer-implemented method of claim 1, wherein the first instance of input includes a first portion of input data, where the input data is divided into a plurality of chronologically arranged portions.

10. A computer program product for performing a hierarchical simplification of learning models, the computer program product comprising a computer readable storage medium having program instructions embodied therewith, wherein the computer readable storage medium is not a transitory signal per se, the program instructions executable by a processor to cause the processor to perform a method comprising:
applying, by the processor, a first instance of input to a first model within a tree structure;
activating, by the processor, a second model within the tree structure, based on an identification of a first topic within the first instance of input by the first model;
applying, by the processor, a second instance of input to the first model and the second model;
activating, by the processor, a third model within the tree structure, based on an identification of a second topic within the second instance of input by the second model;
applying, by the processor, a third instance of input to the first model, the second model, and the third model; and
outputting, by the third model, an identification of a third topic, utilizing the processor and the third instance of input.

11. The computer program product of claim 10, wherein the first model includes a first neural network.

12. The computer program product of claim 10, wherein the tree structure represents a plurality of individual models, as well as an interrelationship between the individual models.

13. The computer program product of claim 10, wherein the tree structure is arranged based on topic.

14. The computer program product of claim 10, wherein first module includes a classification module that outputs a topic based on provided input.

15. The computer program product of claim 10, wherein first instance of input is selected from a group consisting of textual data, audio data, and time series data.

16. The computer program product of claim 10, wherein in response to the identification of the first topic within the first instance of input, all children of the first model within the tree structure are activated.

17. The computer program product of claim 10, wherein the first model includes a root model within the tree structure, the second model includes an intermediate model within the tree structure, and the third model includes a terminal model within the tree structure.

18. The computer program product of claim 10, wherein the first instance of input includes a first portion of input data, where the input data is divided into a plurality of chronologically arranged portions.

19. A system, comprising:
a processor; and
logic integrated with the processor, executable by the processor, or integrated with and executable by the processor, the logic being configured to:
apply a first instance of input to a first model within a tree structure;
activate a second model within the tree structure, based on an identification of a first topic within the first instance of input by the first model;
apply a second instance of input to the first model and the second model;
activate a third model within the tree structure, based on an identification of a second topic within the second instance of input by the second model;
apply a third instance of input to the first model, the second model, and the third model; and
output, by the third model, an identification of a third topic, utilizing the third instance of input.

20. A computer-implemented method, comprising:
identifying a complex model that determines a plurality of topics within input data;
decomposing the complex model into a plurality of simplified models, where each simplified model is associated with one of the plurality of topics and identifies the one of the plurality of topics within the input data;
determining a relationship between the plurality of topics;
arranging the plurality of simplified models into a hierarchical tree structure, based on the relationship between the plurality of topics;
training each of the plurality of simplified models within the hierarchical tree structure; and
applying the trained plurality of simplified models to the input data.

21. The computer-implemented method of claim 20, wherein each of the plurality of simplified models is associated with a topic different from other topics associated with other simplified models within the plurality of simplified models.

22. The computer-implemented method of claim 20, wherein subordinate models to a superordinate model are arranged as children of the superordinate model within the hierarchical tree structure.

23. The computer-implemented method of claim 20, wherein the input data is sequentially organized.

24. The computer-implemented method of claim 20, wherein an immediate child of a root model within the hierarchical tree structure is initially applied to a first portion of the input data.

25. A computer program product for performing a hierarchical simplification of learning models, the computer program product comprising a computer readable storage medium having program instructions embodied therewith, wherein the computer readable storage medium is not a transitory signal per se, the program instructions executable by a processor to cause the processor to perform a method comprising:
identifying, by the processor, a complex model that determines a plurality of topics within input data;
decomposing, by the processor, the complex model into a plurality of simplified models, where each simplified model is associated with one of the plurality of topics and identifies the one of the plurality of topics within the input data;
determining, by the processor, a relationship between the plurality of topics;
arranging, by the processor, the plurality of simplified models into a hierarchical tree structure, based on the relationship between the plurality of topics;
training, by the processor, each of the plurality of simplified models within the hierarchical tree structure; and
applying, by the processor, the trained plurality of simplified models to the input data.
